(19) United States
(12) Patent Application Publication
(10) Pub. No.: US 2026/0050900 A1
(43) Pub. Date: Feb. 19, 2026

(54) REMOTE AGENT SYSTEM

(71) Applicant: SITA Information Networking Computing USA, Inc., Atlanta, GA (US)

(72) Inventors: Balwin ATWAL, Saint James, NY (US); Renaldo CATANZARITI, Sydney (AU); Richard UNGRO, Lake Ronkonkoma, NY (US); Mazen EL-CHAMAA, Montreal (CA); Carl DUFRESNE, Commack, NY (US)

(21) Appl. No.: 19/243,789

(22) Filed: Jun. 20, 2025

Related U.S. Application Data
(63) Continuation of application No. PCT/US2023/084566, filed on Dec. 18, 2023.
(60) Provisional application No. 63/476,834, filed on Dec. 22, 2022.

(51) Int. Cl. G06Q 20/18

(52) U.S. Cl. CPC G06Q 20/18

(57) ABSTRACT

A kiosk or terminal for use by a passenger, customer or user is provided the kiosk or terminal comprising: detector configured to detect presence and/or movement of the passenger, customer or user in a predetermined area defined in relation to the kiosk or terminal; wherein the detector is communicatively coupled to a module wherein the module is configured to: receive a detection signal from the detector in response to the presence and/or movement of the passenger, customer or user within the predetermined area; in response to receiving the detection signal, initiate a session with a remote agent terminal; wherein the kiosk is configured to allow the agent to remotely login to the kiosk and to control the kiosk and/or view a display device of the kiosk to complete one or more functions initiated by the user. A corresponding method, a computer program and a system are also provided.

### CROSS-REFERENCE TO RELATED APPLICATIONS

This application is a continuation application of International patent application PCT/US2023/084566, filed on Dec. 18, 2023, and entitled “REMOTE AGENT SYSTEM,” which claims the benefit of, and priority to, U.S. Provisional App. No. 63/476,834, filed on Dec. 22, 2022, and entitled “REMOTE AGENT SYSTEM,” the contents of which are hereby incorporated by reference in their entireties as if set forth herein.

### FIELD OF THE INVENTION

This invention relates to a workstation, terminal, or kiosk and in particular to a self-service kiosk. Further, this invention relates to a workstation, terminal or kiosk for use by users such as passengers at an airport. More particularly, this invention relates to a system, workstation, terminal, or kiosk which is remotely accessible by an agent whilst also being configured to be used by a user or passenger.

### BACKGROUND OF THE INVENTION

Airline agents provide check-in assistance to process passengers at airports. Currently, agents must be physically present at an airport to assist passengers who need assistance for their check-in process to obtain boarding passes, baggage tags and accept baggage for example.

Further, there is currently no airline agent assistance available for check-in equipment deployed outside an airport or when the agents are not on duty. Having agents available at airports adds significant cost to the airlines. Further, agents can only cover a very limited check-in area that is available to passengers going through check-in process.

### SUMMARY OF THE INVENTION

The invention aims to address these problems by providing a system, terminal or kiosk which is simultaneously be usable by a passenger and by a remote agent to assist the passenger.

Embodiments of the invention allow airline agents to assist passengers at any check-in location within an airport or outside an airport. Agents may be located at a central airlines locations in any country or airlines hub airports to serve all airports. Agents may work from home or any mobile location to assist passengers by simply having access to Internet and from any device with access to a browser. The solution provides cloud based services that lowers cost and provides a highly efficient operational model. Embodiments of the invention allows for segregation of the airport environment from the airlines agent devices thus allowing all entities to evolve based on their needs. Embodiments of the invention provide an easy to use portal for airlines agents and seamless process for assisting passengers by live bi-directional video communication with passengers and access to all the application required to process passengers. Embodiments of the invention include the hardware required at a passenger touchpoint to facilitate live communication with a remote available airline agents. Embodiments of the invention may comprise, but are not limited to any one or more of: one or more proximity sensors to detect a passenger or user, a directional microphone and one or more speakers as well as dual virtual monitors that allow an agent see the passenger and the airline applications.

### BRIEF DESCRIPTION OF THE DRAWINGS

Embodiments of the invention will now be described, by way of example only, and with reference to the accompanying drawings, in which:

FIG. 1 is a schematic diagram of a terminal or kiosk embodying the invention;

FIG. 2 is a further schematic diagram of a system embodying the invention including the terminal or kiosk;

FIG. 3 is system architecture diagram including the main steps performed by an embodiment of the invention;

FIG. 4 is a sequence flow diagram showing the messaging which occurs between an airline application and a peripheral manager, according to an embodiment;

FIG. 5 is a sequence flow diagram showing exemplary interactions between a kiosk, a remote agent, a device service, and cloud service, according to an embodiment; and

FIG. 6 is an exemplary agent portal interface for initiating remote assist and screen sharing, according to an embodiment.

The following description is of a kiosk application for use by any one of a number of merchants, passengers or users including airline agents but this is exemplary and other applications of the invention will be also be discussed.

For example, embodiments of the invention may also find application in any shared or common use environment, where multiple merchants share common space, workstations, mobile, kiosks, self-bag drop and other infrastructure. Exemplary environments are: airport kiosks, parking, ground transportation, gates and check-in areas; buses, hotel check-in/out areas, kiosks and room based ordering services; government services; security, license provisioning, park passes, vendor provisioning; shopping mall, multi-merchant stores or markets, retail order and checkout; car rental kiosks; telephone card dispensing; food court ordering and pickup; takeout and food ordering systems; train ticketing and check-in; and taxi stands. Embodiments of the invention may have general application in the transportation or travel industries and moreover in any environment where infrastructure is shared by a number of different users, such as shipping, rail, and road transportation.

### Data Flow Across Interfaces

The following section describes the data flow according to embodiments of the invention with particular focus on the transport protocol, message format, encryption, and data payload.

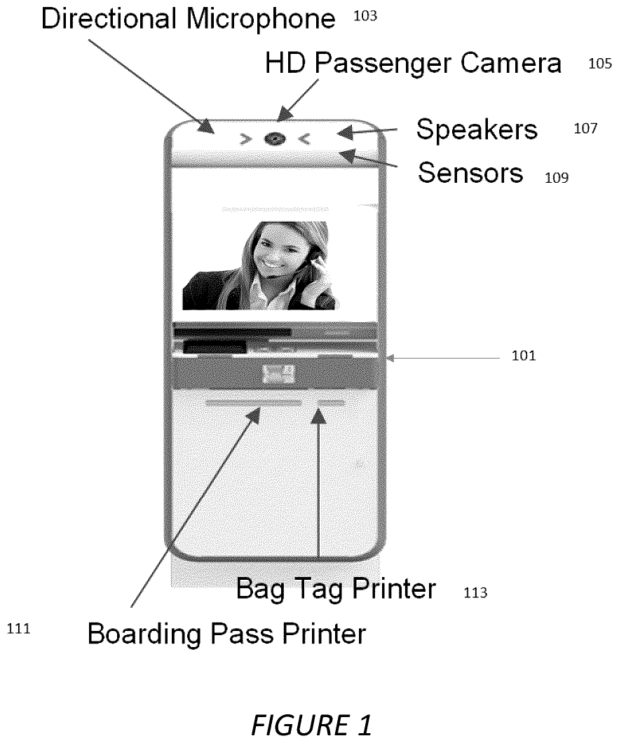

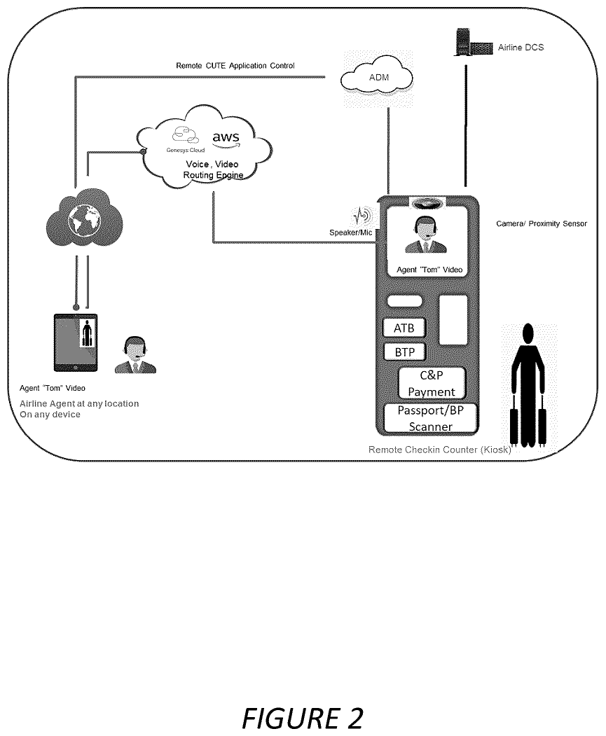

Referring first to FIG. 1 of the drawings, the kiosk or terminal 101 may comprise any one or more of a directional microphone 103, a camera 105, a speaker or speakers 107, one or more proximity sensors 109, a boarding pass printer 111 and a bag tag printer 113. The speaker 107 is usually positioned on a front face of the terminal in order to transmit audio sound to a user facing the terminal 101. Similarly, the camera 105 is positioned on a front face of the terminal to capture an image or video of the passenger or user. Similarly, the proximity sensor or sensors 109 are usually positioned on a front face of the terminal 101 and are configured to detect a passenger or user approaching the terminal 101. The boarding pass printer 111, although not visible in FIG. 1 is positioned inside the terminal 101 and a boarding pass may be printed using the printer and issues from a slot in the front of the kiosk. Similarly, the bag tag printer 113, although not visible in FIG. 1 is positioned inside the terminal 101 and a bag tag pass may be printed using the printer and issues from a slot in the front of the kiosk.

The microphone 103 is also positioned on a front face of the terminal 101 and is configured to capture audio sound generated by the passenger or user.

### Flow Description

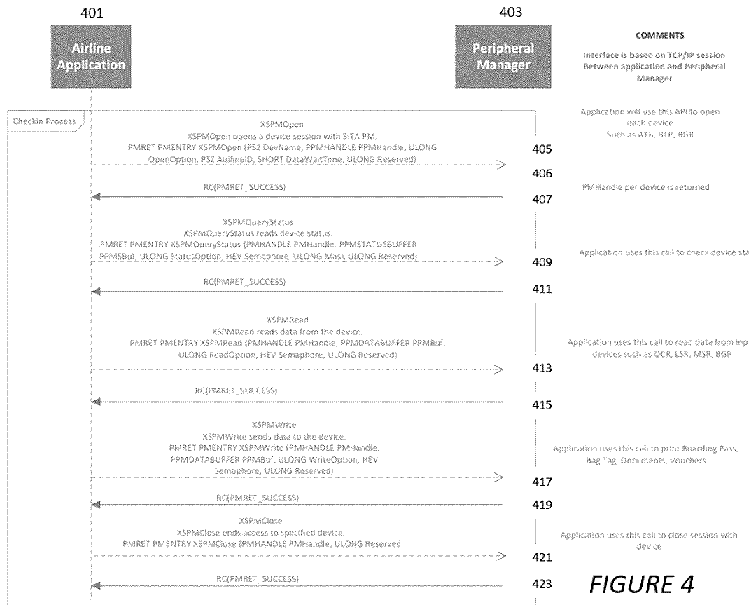

Referring now to the sequence flow diagram of FIG. 4 of the drawings, key steps performed by an embodiment of the invention will be described. This Figure shows the messaging which takes place between an airline application 401 running on the terminal or kiosk 101 and a peripheral manager 403. In FIG. 4, message payload is shown in brackets (. . . ), and the name of each message is shown before the brackets. The interface shown in FIG. 4 is based on a TCP/IP session between the application 401 and the peripheral manager 403.

At step 405 the airline application sends an XSPMOpen message to the peripheral manager 403. Subsequently, a device session with each device such as a bag tag printer, boarding pass printer or bag tag reader is opened. This is achieved at step 406 by the airline application sending a PMRET PMENTRY XSPMOpen message 406 to the peripheral manager. The PMRET PMENTRY XSPMOpen message may contain a payload of any one or more of a device name, a handle, a ULONG OpenOption, an airline identifier, a wait time, and a ULONG Reserved. This allows the peripheral manager to open each device on the terminal 101 such as a boarding pass printer 111, bag tag printer 113 and a scanner 114 (not shown in FIG. 1 of the drawings) such as a passport scanner or barcode reader for reading bag tags. At 407, a PMHandle per device is returned in an RC message which contains a payload of PMRET_SUCCESS.

At step 409 a message or call is sent by the airline application 401 to the peripheral manage 403 to check the status of each device. The message may be a PMRET PMENTRY XSPMQueryStatus message and may contain a payload of any one or more of a PM handle, PPMSTATUSBUFFER PPMSBuf, a status option, an HEV Semaphore, a ULONG Mask, and a ULONG Reserved.

At step 411, the peripheral manager 403 returns a PMHandle per device in an RC message which contains a payload of PMRET_SUCCESS.

At step 413 the airline application 401 sends a call to read data from input devices on the kiosk or terminal 101. The devices may be any one or more of an Optical Character Recognition scanner, a Laser Scanner, an MSR, or a bag tag reader. This may be a PMRET PMENTRY XSPMRead message and may comprise a payload of any one of more of PMHANDLE PMHandle, PPMDATABUFFER PPMBuf, ULONG ReadOption, HEVSemaphore, ULONG Reserved.

At step 415, the peripheral manager 403 returns a PMHandle per device in an RC message which contains a payload of PMRET_SUCCESS.

At step 417 the airline application 401 sends a call to print any one or more of a boarding pass, or a bag tag or other documents or vouchers. The call may be a PMRET PMENTRY XSPMWrite call and may comprise a payload of any one or more of PMHANDLE PMHandle, PPMDATABUFFER PPMBuf, ULONG WriteOption, HEV Semaphore, ULONG Reserved.

At step 419, the peripheral manager 403 returns a PMHandle per device in an RC message which contains a payload of PMRET_SUCCESS.

At step 421, the airline application 401 sends a call to close the session with the PM device 403. The call or message may be a PMRET PMENTRY XSPMClose message and may comprise a payload of any one or more of PMHANDLE PMHandle, ULONG Reserved.

At step 423, the peripheral manager 403 returns a PMHandle per device in an RC message which contains a payload of PMRET_SUCCESS.

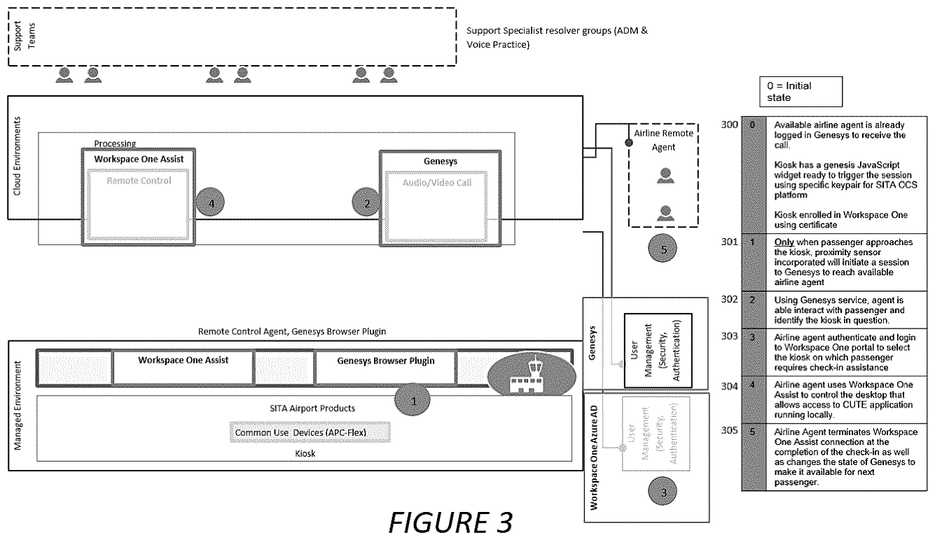

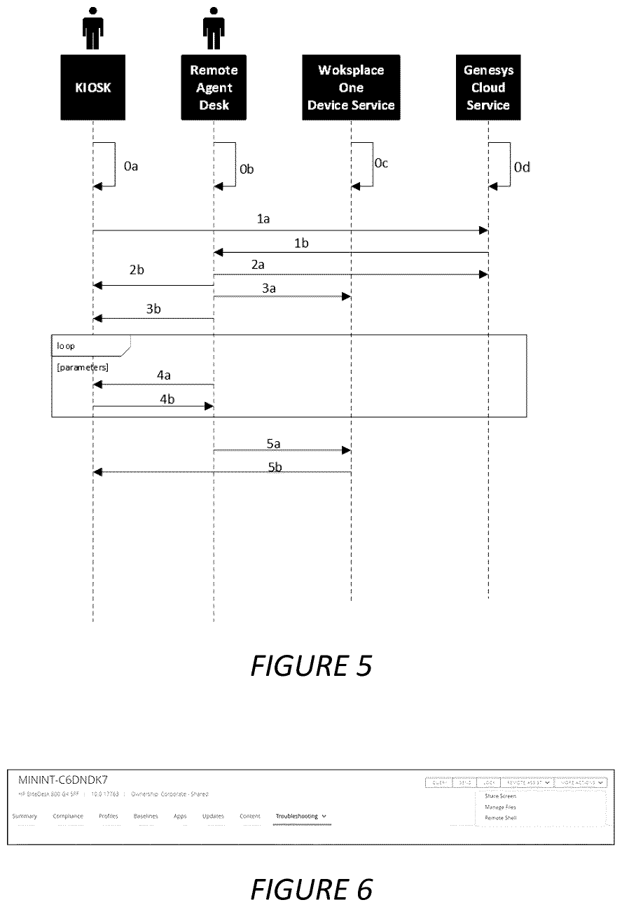

FIG. 3 shows an exemplary system architecture diagram and main steps (Steps 0-5) performed by an embodiment of the invention. The architecture diagram and Steps 0-5 will be explained in relation to the exemplary sequence flow diagram shown in FIG. 5, illustrating exemplary interactions between a kiosk, a remote agent, a device service, and cloud service, according to an embodiment. Although the exemplary interactions are explained in relation to Steps 0-5, it will be appreciated that, in other embodiments, one or more of the steps 0-5 may be optional, performed in different sequence, and/or be merged into a single step.

As shown in FIGS. 3 and 4, Step 0 300 is an initial state in which available airline agent is already logged in a cloud platform (e.g. Genesys Cloud CX) in order to receive a call (e.g. an audio or video call). Such a cloud platform may be in forms of a Software as a Service (SaaS) solution, a web-based suite, and/or a hybrid cloud software. The kiosk may be configured to trigger a call session. For example, the kiosk may have a Genesis JavaScrip widget for triggering a session. Such triggering may be performed using a specific keypair for a specific contact centre service. Such a contact centre service may be a cloud-based contact service (e.g. SITA Omnichannel Contact Services). The kiosk may be enrolled in a management platform (e.g. Workspace ONE). Such a management platform may enable controlling of end users'mobile devices and/or cloud-hosted virtual desktops and/or applications from the cloud or from an on-premises deployment. The cloud platform may comprise service(s) and/or addon(s) for audio and/or video communication (e.g. Auvious Video channel add-on and/or WebRTC) in order to provide secure voice and/or video communication between the Kiosk and the remote agent.

Optionally, as shown in Step 1 301, the session may be initiated only if a user (e.g. passenger) approaches the kiosk and/or is detected within a predetermined proximity from the kiosk. This may be performed by, for example, using one or more proximity sensors, one or more ultrasound sensors, one or more audio sensors, and/or one or more cameras. Such proximity sensors, audio sensors, ultrasound sensors, and/or cameras which may be parts of the kiosk, or be located near the kiosk and communicatively connected to the kiosk. Optionally, the session may be initiated only if the presence and/or movement of the user is detected within a predetermine area for a predetermined duration. The predetermined area may be, for example, by an area within a specific maximum distance from the kiosk (e.g. within 100 or 50 cm from the kiosk). Optionally, predetermined area may exclude an area within a specific minimum distance from the kiosk. Optionally, the predetermined area may be further limited to an area located in a specific direction from the kiosk (e.g. covering the front 180°angle area of the kiosk). Optionally, the predetermined area may be of a custom-defined shape and/or dimensions (e.g. two-dimensional area or three-dimensional space).

Alternatively or additionally, the session may be triggered upon receiving a request from the user via the kiosk or the user's portable device.

In relation to the exemplary interaction shown in FIG. 5, in Step 1a, the session may be initiated if the user is detected within 50 cm in front of the kiosk for more than 3 seconds.

This may be detected by the WebRTC web client in form of a widget with ultrasound sensor integration. The widget may send a incoming videocall request to the pool of available agents. A welcome message may also be displayed on the kiosk to wait for the next available agent.

When one or more agents become available, in Step 1b, the Genesys may allocate an agent and send a connection request to the kiosk client to establish a WebRTC connection.

Once an agent has been allocated, as shown in Step 2 302, the agent is then able to interact with the passenger and identify the kiosk in question. In relation to the exemplary interaction shown in FIG. 5, in Step 2a, when the connection has been established and the video and voice channels are active between the agent and the kiosk, the agent client may return a “CONNECTED” message to the platform to inform the queue that this agent is busy. In Step 2b, video and voice media are established between the agent's WebRTC client and the Kiosk WebRTC client. Therefore, interaction may begin between the agent and the passenger via one or more cameras and microphones. The microphones may have noise-cancellation features which may be hardware and/or software based. The microphones may be directional. Such noise-cancelling and/or directional microphones may be particularly used if the passenger is located in a crowded and noisy environment, such as an airport.

As shown in Step 3 303, the agent may then authenticate and logon to the cloud platform to select the kiosk on which the passenger requires assistance. Optionally, the selection of the kiosk may be automatically performed based on kiosk information received. In relation to the exemplary interaction shown in FIG. 5, in Step 3a, airline agent may authenticate and login to Workspace One portal to select the kiosk on which passenger requires check-in assistance, and in Step 3b, the agent may select Remote Assist/Share screen from the endpoint dashboard. During this step, a connection between Workspace One and remote kiosk may be established. FIG. 6 shows an explementary agent portal interface for initiating remote assist and screen sharing.

As shown in Step 4 304, the agent may then control the desktop that allows access to a Common Use Terminal Equipment (CUTE) application running locally, using Workspace One Assist. In relation to the exemplary interaction shown in FIG. 5, in Step 4a, the airline agent may use Workspace One Assist to control the desktop that allows access to passenger processing application running locally, and in Step 4b, the agent may use remote connection to execute passenger processing operations.

Therefore, the agent may, for example, use CUTE application to interact with the kiosk peripherals and airline Departure Control System (DCS) to perform passenger check-in which may involve reading passport, taking payment, printing receipt, printing boarding pass, printing baggage tag, and/or controlling the baggage belt scale to accept passenger baggage.

As shown in Step 5 305, the agent may then terminate Workspace One Assist connection at the completion of the passenger processing operation. Upon or after the termination of the connection, the state of Genesys may be changed so indicate that the agent is available. In relation to the exemplary interaction shown in FIG. 5, in Step 5a, the airline agent may use Workspace One Assist to logoff the remote computer at the completion of the passenger support session, and in Step 5b the agent may complete remote disconnection.

Although one or more of the above examples has been described with reference to a payment system for use in the aviation industry, it will be clear from the foregoing explanation embodiments of the invention may advantageously be used in any environment where a workstation, mobile, self-service or other such terminal is shared between a number of different users and when each user has their own application running on the workstation, mobile, self-service or other such terminal in which a single reader is communicatively coupled to these such terminals.

From the foregoing, it will be appreciated that the system may comprise a computer processor running one or more server processes for communicating with client devices. The server processes comprise computer readable program instructions for carrying out the operations of the present invention. The computer readable program instructions may be or source code or object code written in or in any combination of suitable programming languages including procedural programming languages such as C, object orientated programming languages such as C #, C++, Java, scripting languages, assembly languages, machine code instructions, instruction-set-architecture (ISA) instructions, and state-setting data.

The wired or wireless communication networks described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

The system described above may comprise a Graphical User Interface. Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as a circuit board which may include a CPU, a bus, RAM, flash memory, one or more ports for operation of connected I/O apparatus such as printers, display, keypads, sensors and cameras, ROM, a communications sub-system such as a modem, and communications media.

In addition, the above detailed description of embodiments of the invention are not intended to be exhaustive or to limit the invention to the precise form disclosed. For example, while processes or blocks are presented in a given order, alternative embodiments may perform routines having steps, or employ systems having blocks, in a different order, and some processes or blocks may be deleted, moved, added, subdivided, combined, and/or modified.

Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure.

1-29. (canceled)

30. A kiosk or terminal for use by a passenger, customer or user, the kiosk or terminal comprising:
a. a detector configured to detect presence and/or movement of the passenger, customer or user in a predetermined area defined in relation to the kiosk or terminal;
wherein the detector is communicatively coupled to a module wherein the module is configured to:
i. receive a detection signal from the detector in response to the presence and/or movement of the passenger, customer or user within the predetermined area;
ii. in response to receiving the detection signal, initiate a session with a remote agent terminal;
iii. wherein the kiosk is configured to allow the agent to remotely login to the kiosk and to control the kiosk and/or view a display device of the kiosk to complete one or more functions initiated by the user.

31. The kiosk or terminal of claim 30, wherein the detector comprises one or more of: one or more proximity sensor, one or more audio sensor, one or more ultrasound sensors, and/or one or more camera.

32. The kiosk or terminal of claim 30, wherein the session with the remote agent terminal is initiated only if the presence and/or movement of the passenger, customer or user is detected within the predetermined area for a longer consecutive period of time exceeding a set minimum duration.

33. The kiosk or terminal of claim 30, wherein the predetermined area is defined according to a maximum and/or minimum distances from the kiosk or terminal.

34. The kiosk or terminal of claim 30, wherein the predetermined area is defined according to a range of angle in relation to the kiosk or terminal.

35. The kiosk or terminal of claim 30, wherein the predetermined area comprise one or more of two-dimensional areas and/or three-dimensional spaces.

36. The kiosk or terminal of claim 30, further comprising one or more microphones and/or cameras for providing sound and/or video feeds for the session.

37. The kiosk or terminal of claim 36, wherein the one or more microphones are noise-cancelling microphones.

38. The kiosk or terminal of claim 36, wherein the one or more microphones are directional microphones.

39. The kiosk or terminal of claim 30, wherein, prior to initiating the session, the kiosk or terminal is configured to connect to a portable device associated with the passenger, customer or user to receive a session request via the portable device.

40. The kiosk or terminal of claim 30, wherein, the kiosk or terminal is configured to connect to a portable device associated with the passenger, customer or user to receive a voice and/or video feeds via the portable device.

41. The kiosk or terminal of claim 30, wherein, the kiosk or terminal is configured to connect to a portable device associated with the passenger, customer or user to transmit a voice and/or video feeds from the agent to the portable device.

42. The kiosk or terminal of claim 30, configured for use in a system for simultaneous use by a user and a remote agent, wherein the kiosk or terminal is further configured to:
identify the kiosk using the session;
wherein the session with the remote agent allows the agent to authenticate and login to a portal wherein the portal is configured to automatically select or allow the agent to select the kiosk which the passenger is using from a plurality of remote kiosks.

43. The kiosk or terminal of claim 42, wherein the portal is configured to initiate controlling of the kiosk and/or viewing of a display device of the kiosk to complete one or more functions initiated by the user.

44. A method for initiating a remote session at a kiosk or terminal for use by a passenger, customer or user, the method comprising:
a. detecting presence and/or movement of the passenger, customer or user in a predetermined area defined in relation to the kiosk or terminal by a detector;
wherein the detector is communicatively coupled to a module wherein the module is configured to:
iv. receive a detection signal from the detector in response to the presence and/or movement of the passenger, customer or user within the predetermined area;
v. in response to receiving the detection signal, initiate a session with a remote agent terminal;
vi. wherein the kiosk is configured to allow the agent to remotely login to the kiosk and to control the kiosk and/or view a display device of the kiosk to complete one or more functions initiated by the user.

45. The method of claim 44, wherein the detector comprises one or more of: one or more proximity sensor, one or more audio sensor, one or more ultrasound sensors, and/or one or more camera; and or wherein the session with the remote agent terminal is initiated only if the presence and/or movement of the passenger, customer or user is detected within the predetermined area for a longer consecutive period of time exceeding a set minimum duration; and or wherein the predetermined area is defined according to a maximum and/or minimum distances from the kiosk or terminal; and or wherein the predetermined area is defined according to a range of angle in relation to the kiosk or terminal; and or wherein the predetermined area comprise one or more of two-dimensional areas and/or three-dimensional spaces.

46. The method of claim 44, further comprising one or more microphones and/or cameras for providing sound and/or video feeds for the session;
preferably wherein the one or more microphones are noise-cancelling microphones, and or wherein the one or more microphones are directional microphones.

47. The method of claim 44, further comprising, prior to initiating the session, connecting the kiosk or terminal to a portable device associated with the passenger, customer or user to receive a session request via the portable device; and/or wherein, the kiosk or terminal is configured to connect to a portable device associated with the passenger, customer or user to receive a voice and/or video feeds via the portable device; and/or wherein, the kiosk or terminal is configured to connect to a portable device associated with the passenger, customer or user to transmit a voice and/or video feeds from the agent to the portable device.

48. A computer program product which, when executed, is configured to perform the method of claim 44.

49. A kiosk or terminal of claim 30, wherein the detector is a proximity sensor configured to detect the passenger, customer or user.
